(19) United States
(12) Patent Application Publication
(10) Pub. No.: US 2010/0096959 A1
(43) Pub. Date: Apr. 22, 2010

(54) PODIUM WITH SECURE ACCESS PANEL

(76) Inventor: Raymond A. Weaver, Danville, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/482,541

(22) Filed: Jun. 11, 2009

Related U.S. Application Data
(60) Provisional application No. 61/060,961, filed on Jun. 12, 2008.

(51) Int. Cl. A47B 96/16; A47B 81/00; E05B 65/46

(52) U.S. Cl. 312/109; 312/223.1; 312/215

(57) ABSTRACT

A podium includes a plurality of sides and an upper surface forming an enclosure having a hollow interior space, at least one door covering an unhidden access opening for providing access to the interior space and located in a rearward one of the sides, and a sliding access panel removably covering a hidden access opening for providing access to the interior space and located in a forward one of the sides. The access panel is visibly concealed so that it is not apparent that the access panel is movable to provide access to the interior space. A lock is provided for locking and unlocking the sliding access panel in its closed position. The lock is located within the interior space so that the sliding access panel is locked and unlocked from within the interior space and the lock is not visible from outside the podium.

### CROSS-REFERENCE TO RELATED APPLICATIONS

This application claims the priority benefit of U.S. Provisional Patent Application No. 61/060,961 filed on Jun. 12, 2008, the disclosure of which is expressly incorporated herein in its entirety by reference.

### STATEMENT REGARDING FEDERALLY SPONSORED RESEARCH

Not Applicable

### REFERENCE TO APPENDIX

Not Applicable

### FIELD OF THE INVENTION

The field of the present invention generally relates to podiums and, more particularly, to podiums that house electronic equipment such as computers, sound system equipment, video projection equipment, teleprompting equipment, and the like.

### BACKGROUND OF THE INVENTION

Podiums or lecterns are typically used by speakers or lecturers in speaking or lecturing to an audience. A speaker may utilize the podium to hold notes or other materials. Such podiums may be used in many situations such as teaching, presentations, speeches and the like in many different environments such as lecture halls, classrooms, conference rooms, chapels, convention centers, stages, auditoriums, gymnasiums, and the like.

Podiums are often constructed with interior compartments designed to house electronic equipment such as computers, sound system equipment, video projection equipment, teleprompting equipment, and the like. When housing electronic equipment, podiums are preferably constructed with access doors and/or panels which provide access to both the front and rear of the electronic equipment so that operation as well as necessary connections and disconnections can be easily managed. These access doors and/or panels must be selectively secured to prevent unauthorized access to the electronic equipment which can result in theft and, particularly in the educational environment, pranks.

One solution to this problem has been to provide a lock or locks to secure all of the access doors and/or panels. These locks, however, are often left in an unlocked condition in environments such as classrooms. Another solution has been to secure the access doors and/or panels which provide access to the rear side of the electronic equipment with mechanical fasteners such as screws or the like. This solves the problem because it is difficult to disconnect or alter the connections of the electronic equipment even if the podium is left in an unlocked condition. However, this also makes it more difficult to disconnect or alter the connections of the electronic equipment when it is legitimately desired to do so. Accordingly, there is a need in the art for improved podiums which house electronic equipment.

### SUMMARY OF THE INVENTION

The present invention provides a podium which overcomes at least some of the above-noted problems of the related art. Disclosed herein is a podium comprising, in combination, a plurality of upwardly extending sides and an upper surface forming an enclosure having a hollow interior space, at least one door covering an unhidden access opening for selectively providing access to the interior space and located in a rearward one of the upwardly extending sides, and a sliding access panel removably covering a hidden access opening for selectively providing access to the interior space and located in a forward one of the upwardly extending sides. The sliding access panel is visibly concealed so that it is not apparent that the sliding access panel is movable to provide access to the interior space.

Also disclosed is a podium comprising, in combination, a plurality of upwardly extending sides and an upper surface forming an enclosure having a hollow interior space, at least one door covering a first access opening for selectively providing access to the interior space and located in a rearward one of the upwardly extending sides, a sliding access panel removably covering a second access opening for selectively providing access to the interior space and located in a forward one of the upwardly extending sides, and a lock for selectively locking and unlocking the sliding access panel in a closed position and located within the interior space so that the sliding access panel is locked and unlocked from within the interior space.

Further disclosed is a podium comprising, in combination, a plurality of upwardly extending sides and an upper surface forming an enclosure having a hollow interior space, at least one door covering an unhidden access opening for selectively providing access to the interior space and located in a rearward one of the upwardly extending sides, and a sliding access panel removably covering a hidden access opening for selectively providing access to the interior space and located in a forward one of the upwardly extending sides. The at least one door is visibly unconcealed so that it is apparent to an observer that the at least one door is movable to provide access to the interior space. The sliding access panel is visibly concealed so that it is not apparent that the sliding access panel is movable to provide access to the interior space. A lock is provided for selectively locking and unlocking the sliding access panel in a closed position. The lock is located within the interior space so that the sliding access panel is locked and unlocked from within the interior space and the lock is not visible from outside the podium.

From the foregoing disclosure and the following more detailed description of various preferred embodiments it will be apparent to those skilled in the art that the present invention provides a significant advance in the technology and art of podiums. Particularly significant in this regard is the potential the invention affords providing a secure podium with relatively easy access. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a front perspective view of a podium according to the present invention;

FIG. 2 is a rear perspective view of the podium of FIG. 1;

FIG. 3 is a rear perspective view of the podium of FIGS. 1 and 2, wherein a plurality of access doors opened;

FIG. 4 is a front perspective view of the podium of FIGS. 1 to 3, wherein a sliding access panel partially removed;

FIG. 5 is a fragmented, perspective view of the podium of FIGS. 1 to 4, wherein the sliding access panel is entirely removed;

FIG. 6 is an enlarged view of a portion of FIG. 5 showing a slot for receiving the sliding access panel;

FIG. 7 is enlarged view showing the bottom of the slot for receiving the sliding access panel;

FIG. 8 is a fragmented, side elevational view of the top of the sliding access panel of the podium of FIGS. 1 to 7, wherein various components are removed for clarity;

FIG. 9 is a fragmented, top plan view of a lock mechanism for the sliding access panel of the podium of FIGS. 1 to 8;

FIG. 10 is side elevational view of the lock mechanism of FIG. 9;

FIG. 11 is a front perspective view of a podium according to a second embodiment of the present invention, wherein a sliding access panel partially removed;

FIG. 12 is a fragmented, side elevational view of the top of the sliding access panel of the podium of FIG. 11, wherein various components are removed for clarity;

FIG. 13 is a front perspective view of a podium according to a third embodiment of the present invention, wherein a sliding access panel partially removed;

FIG. 14 is an enlarged, fragmented, perspective view of the podium of FIG. 13, wherein the sliding access panel is entirely removed; and

FIG. 15 is a fragmented, side elevational view of the top of the sliding access panel of the podium of FIGS. 13 and 14, wherein various components are removed for clarity.

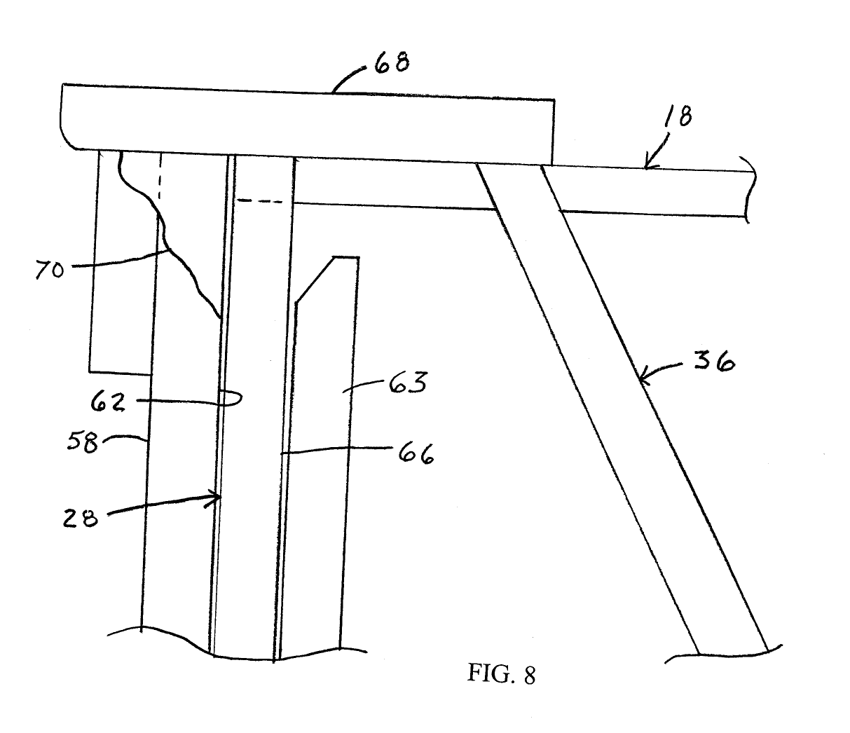

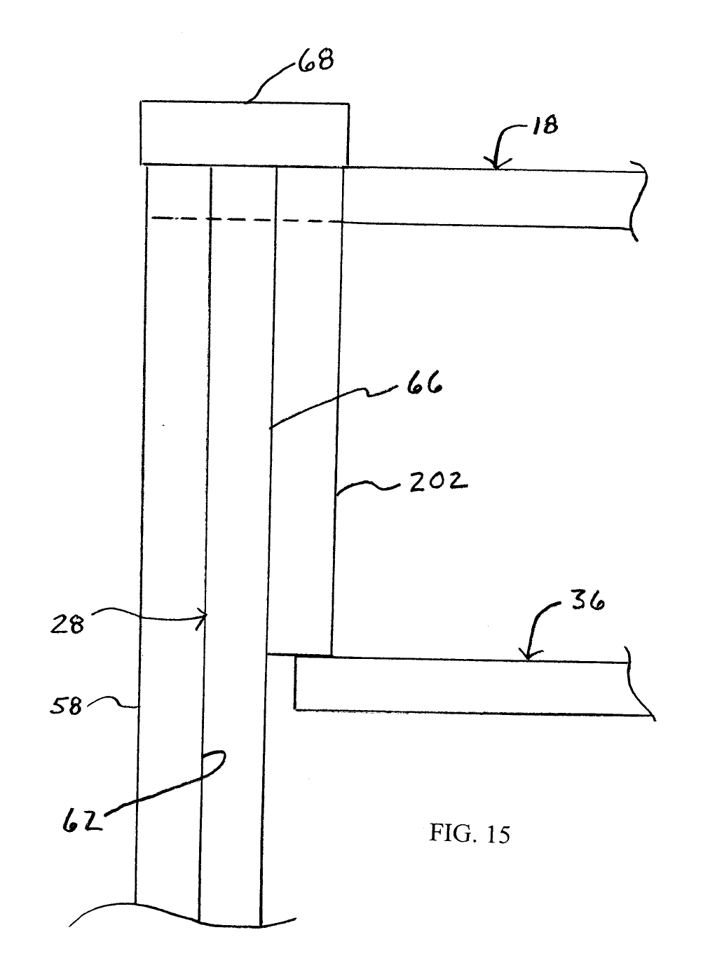

It should be understood that the appended drawings are not necessarily to scale, presenting a somewhat simplified representation of various preferred features illustrative of the basic principles of the invention. The specific design features of podiums as disclosed herein, including, for example, specific dimensions, orientations, locations, and shapes will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the powered adjustable seat assembly illustrated in the drawings. In general, up or upward refers to an upward direction within the plane of the paper in FIGS. 8, 12, and 15 and down or downward refers to a downward direction within the plane of the paper in FIGS. 8, 12, and 15. Also in general, fore or forward refers to a direction toward the left within the plane of the paper in FIGS. 8, 12, and 15 and aft or rearward refers to a direction toward the right within the plane of the paper in FIGS. 8, 12, and 15.

DETAILED DESCRIPTION OF CERTAIN PREFERRED EMBODIMENTS

It will be apparent to those skilled in the art, that is, to those who have knowledge or experience in this area of technology, that many uses and design variations are possible for the improved podiums disclosed herein. The following detailed discussion of various alternative and preferred embodiments will illustrate the general principles of the invention with reference to preferred embodiments. Other embodiments suitable for other applications will be apparent to those skilled in the art given the benefit of this disclosure.

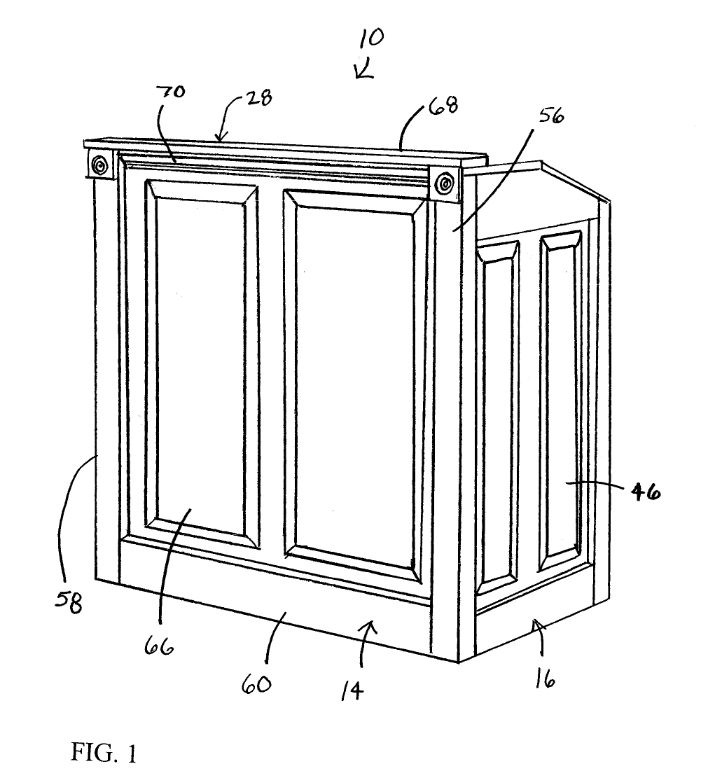

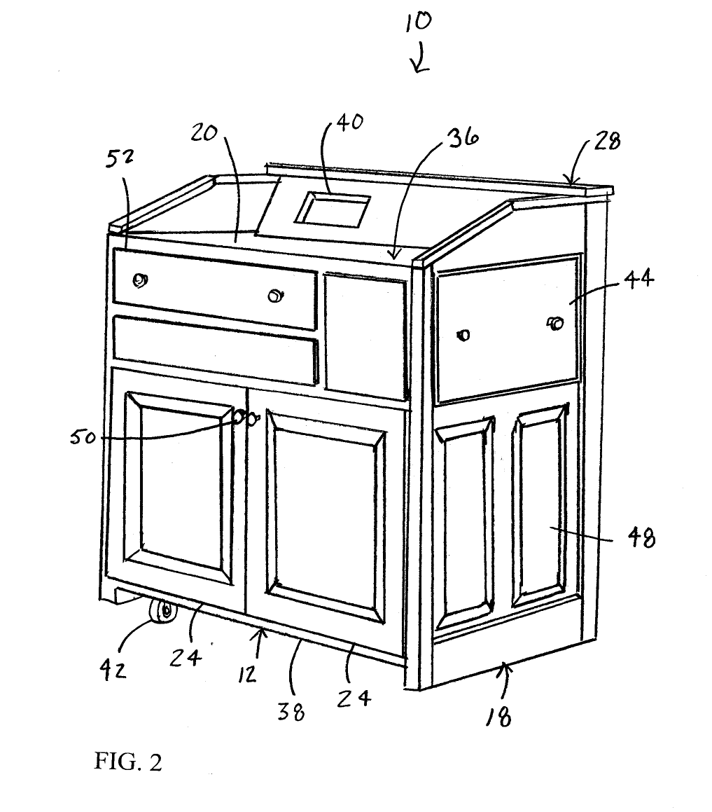

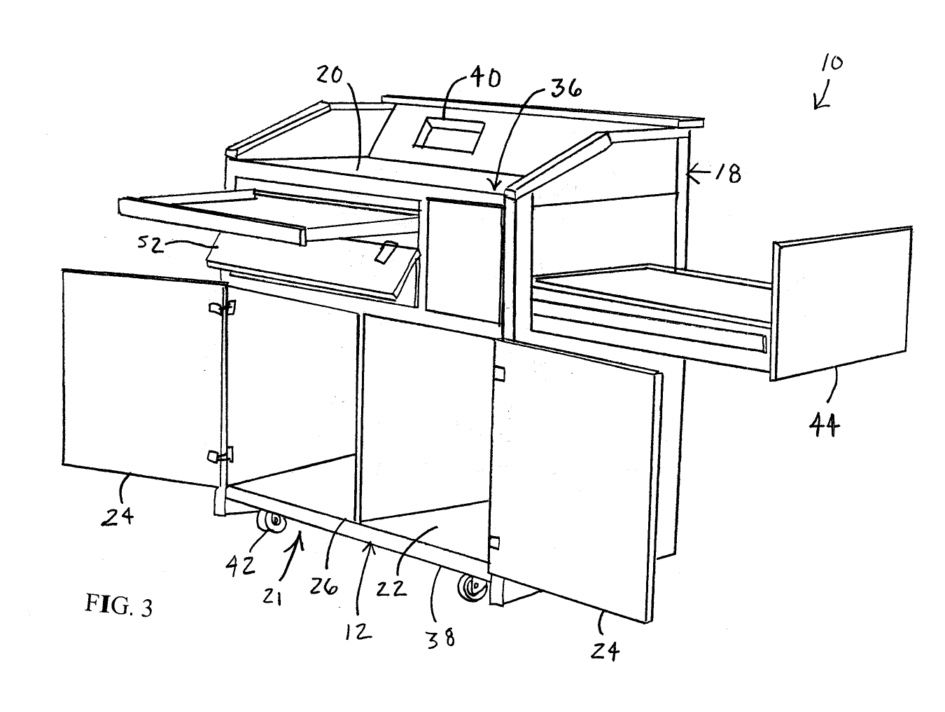

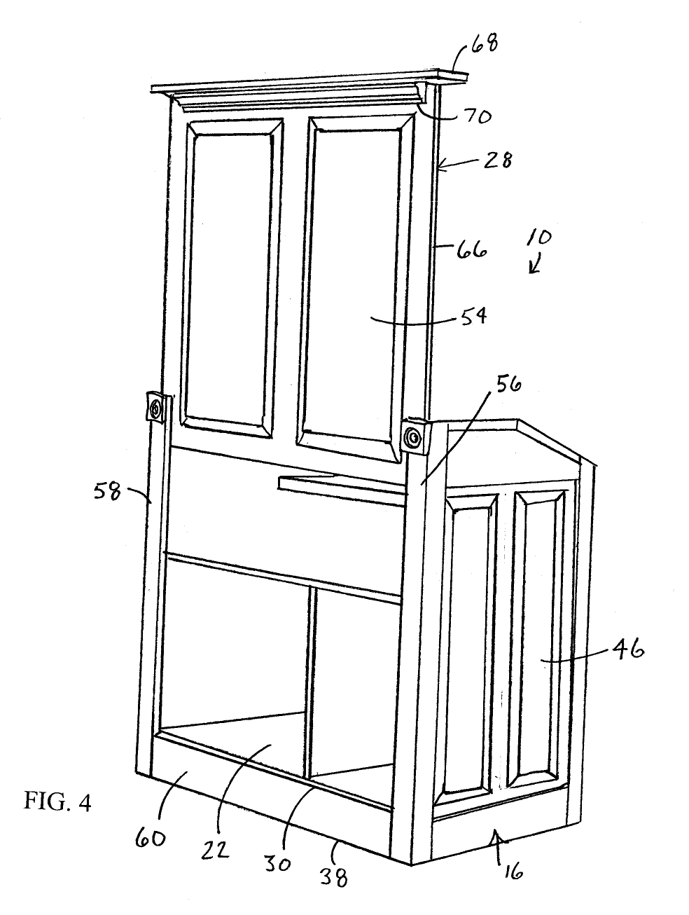

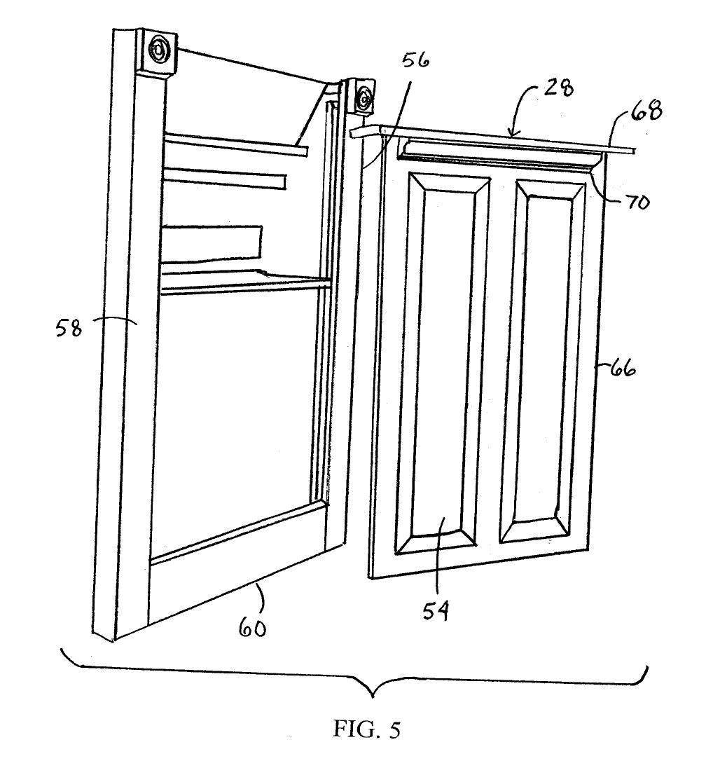

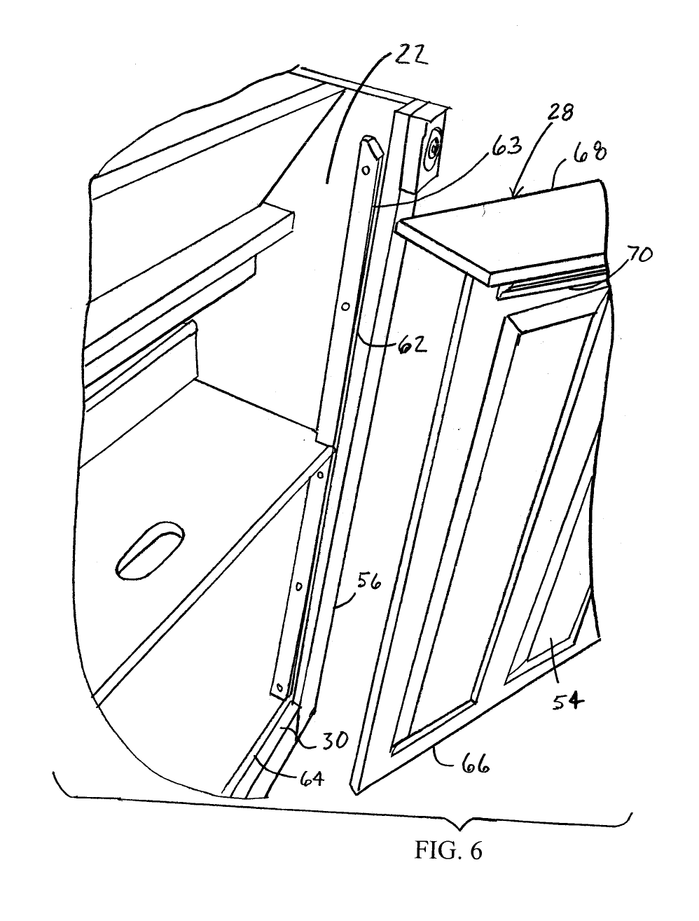

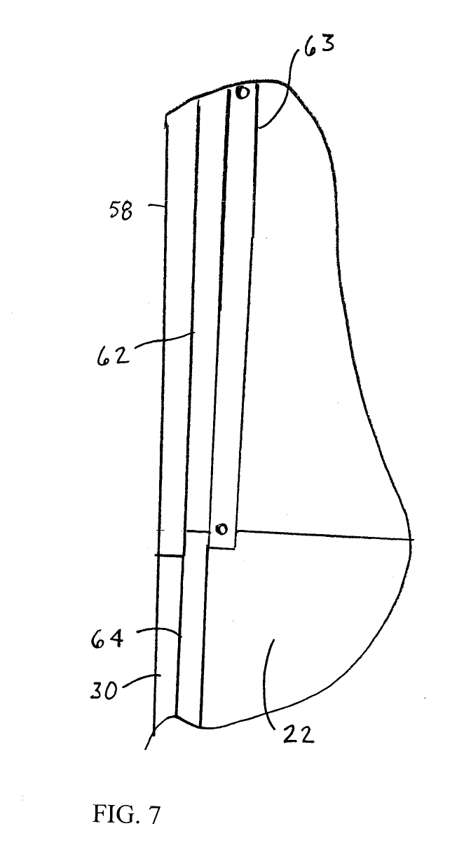

Referring now to the drawings, FIGS. 1 to 8 illustrate a free-standing podium or lectern 10 according to a preferred embodiment of the present invention. The illustrated podium 10 includes a plurality of upwardly extending sides 12, 14, 16, 18 and an upper surface 20 forming an enclosure 21 having a hollow interior space or cavity 22, at least one door 24 covering a first or unhidden access opening 26 for selectively providing access to front controls of electronic equipment 34 located in the interior space 22, a sliding access panel 28 removably covering a second or hidden access opening 30 for selectively providing access to rear connections of the electronic equipment 34 located in the interior space 22, and a lock or lock mechanism 32 for selectively locking and unlocking the sliding access panel 28 in a closed position. The at least one door 24 is visibly unconcealed so that it is visibly apparent to observers that the at least one door 24 is movable to provide access to the interior space 32 and permit operation of front controls on electronic equipment 34 therein. The sliding access panel 28, however, is visibly concealed so that it is not visibly apparent to observers that the sliding access panel 28 is movable to provide access to the interior space 32. Thus, authorized individuals have easy access to the rear connections of electronic equipment 34 in the interior space 32 because they are aware of the sliding access panel 28 but tampering with the rear connections of the electronic equipment 34 is reduced because unauthorized individuals are not aware of the presence of the sliding access panel 28.

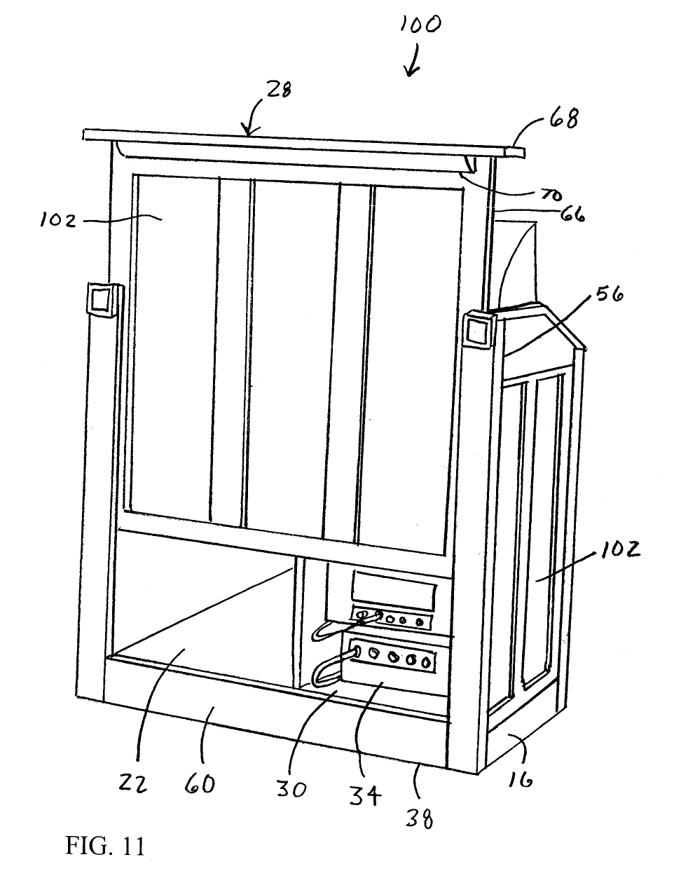

The illustrated enclosure 21 includes a rear side 12, a front side 14, a left side 16, a right side 18, a top side 36, and a bottom side 38 which form the generally hollow interior space 22 for storing electronic equipment 34 (best shown in FIGS. 11 and 13). The illustrated top side 36 has a generally horizontal portion and an angled portion located at a forward end of the horizontal portion which angles upwardly toward the forward direction. The illustrated horizontal portion is adapted for providing the upper writing or a support surface 20 for papers, laptops, and the like. The illustrated angled portion is provided with an opening 40 for am electronic control panel (not shown) for operating electronic components 34 stored within the podium 10. The illustrated bottom side 38 is provided with wheels or casters 42 for moving the podium 10 but alternatively the casters 42 can be eliminated if desired.

The illustrated left and right sides 16, 18 extend above the upper surface 20 to the height of the top of the angled portion of the top side 36 and the front side 14. Toward the rear side 18 of the podium 10, the top of the left and right sides 16, 18 angle down to the height of the horizontal portion of the top side 36. The illustrated right side 18 is provided with an outwardly sliding tray or drawer 44 for holding a printer or the like. The illustrated left and right sides are also provided with decorative raised panels 46, 48.

The illustrated rear side 12 is provided with a pair of the doors 24 for providing access through the first access opening 26 to a lower portion of the interior space 22. The illustrated doors 24 are outwardly hinged but any other suitable type of doors can alternatively be provided such as, for example, sliding doors or the like. It is note that the illustrated doors 24 are raised above the rear surface and have pull knobs 50 so that they are visibly unconcealed. The illustrated rear side 12 is also provided with a downwardly hinged door 52 for providing access to an extendable support tray for a keyboard and the like. It is noted that the doors 24, 52 and drawer 44 can be provided with any suitable type of lock for limiting access to the interior space 22 of the podium 10. It is also noted that the podium 10 can alternatively have any other suitable quantity and/or configuration of doors, trays, drawers, and the like within the scope of the present invention.

The illustrated front side 14 is provided with the sliding access panel 28 which is slidable between an installed or closed configuration wherein access panel 28 is secured to the podium 10 to fully close the second access opening 30 to the interior space 22 and a removed or open configuration wherein the access panel 28 is separated from the podium 10 to open the second access opening 30 and provide access through the second access opening 30 to the electronic equipment 34 in the interior space 22 as described in more detail hereinafter. It is noted that the illustrated access panel 28 is blended into the structure, has no exposed edges or gaps, has no exposed handles, knobs, locks, or the like, and has raised panels 54 to match the left and right sides 16, 18 so that the sliding access panel 28 is visibly concealed. The sliding access panel 28 is visibly concealed so that it is not visibly apparent to observers that the access panel is movable when the access panel 28 is installed. Such construction provides security by deception in that unauthorized individuals will not access the interior space 22 through the second access opening 30 if they do not know that the second access opening 30 exists.

The podium 10 is preferably constructed of wood but any other suitable material can alternatively be utilized. The exterior surfaces of the podium preferably have an aesthetically pleasing appearance. The illustrated podium has a “Traditional” style appearance with the raised panels 46, 48, 54. It is noted, however, any other suitable style can alternatively be utilized within the scope of the present invention such as, for example, a “Contemporary” style (shown in FIG. 11) or a “Modern” style (shown in FIG. 13).

The illustrated sliding access panel 28 forms substantially the entire front side 14 of the podium 10 and slides in a vertical or upward/downward direction so that access panel 28 can be selectively removed from the podium. It is noted that alternatively the sliding access panel 28 can be adapted to be slid to a partially removed position without being entirely removed from the podium 10. The illustrated rear side 12 of the podium 10 has side and bottom members 56, 58, 60 which form a U-shaped frame for the sliding access panel 28 which is open at the top. A pair of vertically extending, inward facing, and spaced-apart grooves or slots 62 are formed at the rearward side of the side members 56, 58 for vertically receiving side edges of the sliding access panel 28. The side grooves 62 are sized to closely receive the lateral edges of the access panel 28 and permit vertical sliding movement of the access panel 28 while minimizing horizontal movement in any direction. The illustrated side grooves 62 are formed by groove members 63 secured to the sides 16, 18 located within the interior space 22 and spaced rearward from the side members 56, 58. Upper ends of the illustrated groove members 63 are angled or notched so that the upper end of the side grooves are expanded in order to ease insertion of the access panel 28 into the grooves 62. A horizontally extending and upward facing groove or slot 64 is formed at a rearward side of the bottom member 60 for receiving a bottom edge of the sliding access panel 28.

The illustrated sliding access panel 28 includes a vertically deposed main panel 66, a horizontally deposed header 68 secured to the top of the main panel 66, and a horizontally disposed molding 70 located below the header 68 and secured to the main panel 66 and the header 68. The main panel 66 is sized and shaped to extend behind the side and bottom members 56, 58, 60 into the grooves 62, 64 to completely close the second access opening 30. The header 68 is sized to extend entirely across the front side 14 and above the side members 56, 58 and the sides 16, 18 of the podium 10. The molding 70 is sized to extend entirely between the side members 56, 58 when the sliding access panel 28 is installed. The various components are sized and shaped to give the same raised panel appearance as the sides 16, 18 of the podium 10. Constructed in this manner, the sliding access panel 28 is visibly concealed and becomes a “hidden” panel.

To install the sliding access panel 28, the access panel 28 is positioned above the front side 14 of the podium 10 and is lowered down so that the lateral side edges of the main panel 66 are received into the side grooves 62. The access panel 28 is lowered until the header 68 engages and rests on the top of the side members 56, 58, the podium sides 14, 16, and the top angled portion of the top side 36. Any gap at the bottom of the access panel 28 is hidden by the bottom member 60 which is sized to cover the bottom edges of the main panel 66. Alternatively, the sliding access panel 28 can rest on its bottom edge but this may permit gaps to be formed below the header 68 unless very close tolerances are maintained. To remove the sliding access panel 28, the access panel 28 is pulled vertically upward until the lateral edges of the main panel 66 are removed from the side grooves 62 and the access panel 28 is completely separated from the remainder of the podium 10.

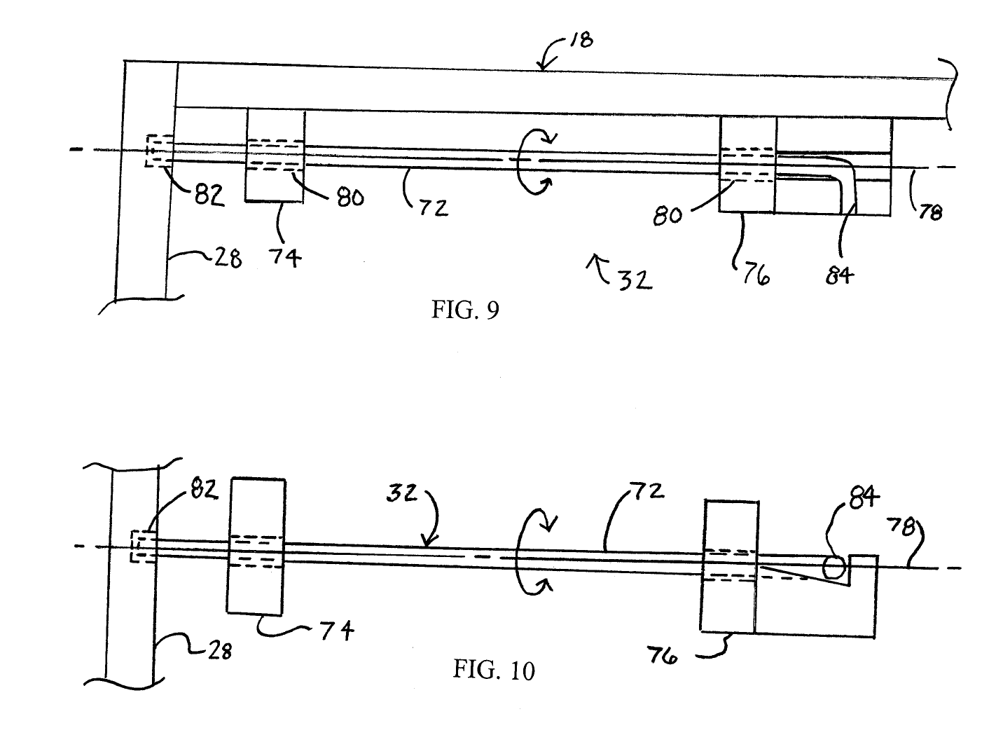

As best shown in FIGS. 9 and 10, the illustrated lock or lock mechanism 32 releaseably secures the sliding access panel 28 in its installed or closed position. The illustrated lock 32 is located entirely within the interior space 22 of the podium 10 and is operable entirely within the interior space 22 of the podium 10 so that the lock 32 is not visible outside the podium 10 which would eliminate the hidden feature of the access door 28. The illustrated lock 28 includes a horizontally-extending rod member 72 which has a straight forward end and a rear end bent at a right angle. The illustrated rod member 72 is disposed in the forward/rearward direction between the first and second access openings 26, 30 and is supported by a pair of support members 74 so that the rod member 72 can longitudinally slide and pivot about its longitudinal axis 76. The illustrated support members 76 are secured to the right side 18 and have horizontally-extending openings 80 through which the rod member 72 extends.

The rod member 72 is manually movable between locked and unlocked positions. In the locked position, the forward end of the rod member 72 extends into a blind opening or hole 82 located on the rear or inner side of the access panel 28 within the interior space 22 and the rearward end of the rod member 72 engages a forward facing abutment 84 to prevent rearward movement of the rod member 72 out of the opening 82. The abutment 84 is laterally spaced from the longitudinal axis 78 of the rod member 72 a distance such that the rear end of the rod member can be pivoted into and out of engagement with the abutment 84. With the rod member 72 extending into the opening 82, the sliding access panel 28 cannot be slid upwardly because upward movement is blocked by the rod member 72. In the unlocked position, the forward end of the rod member 72 is moved out of the blind opening 82 and the rearward end of the rod member 72 is out of engagement with the forward facing abutment 84 so that the rod member 72 is free to move in the rearward direction. With the rod member 72 out of the opening 82, the sliding access panel 28 is free to slide upwardly because upward movement is not blocked by the rod member 72.

To move the lock 32 from the locked position to the unlocked position, the rod member 72 is pivoted about its longitudinal axis 78 so that the rearward end of the rod member 72 is out of engagement with the abutment 84 and then the rod member 72 is slid in a rearward direction until the forward end of the rod member 72 is out of the opening 82. To move the lock from the unlocked position to the locked position, the rod member 72 is slid in a forward direction until the forward end of the rod member 72 is in the opening 82 and then the rod member 72 is pivoted about its longitudinal axis 78 so that the rearward end of the rod member 72 is positioned in front of and in engagement with the abutment 84 to prevent rearward movement of the rod member 72. It is noted that the lock can alternatively be of any other suitable type.

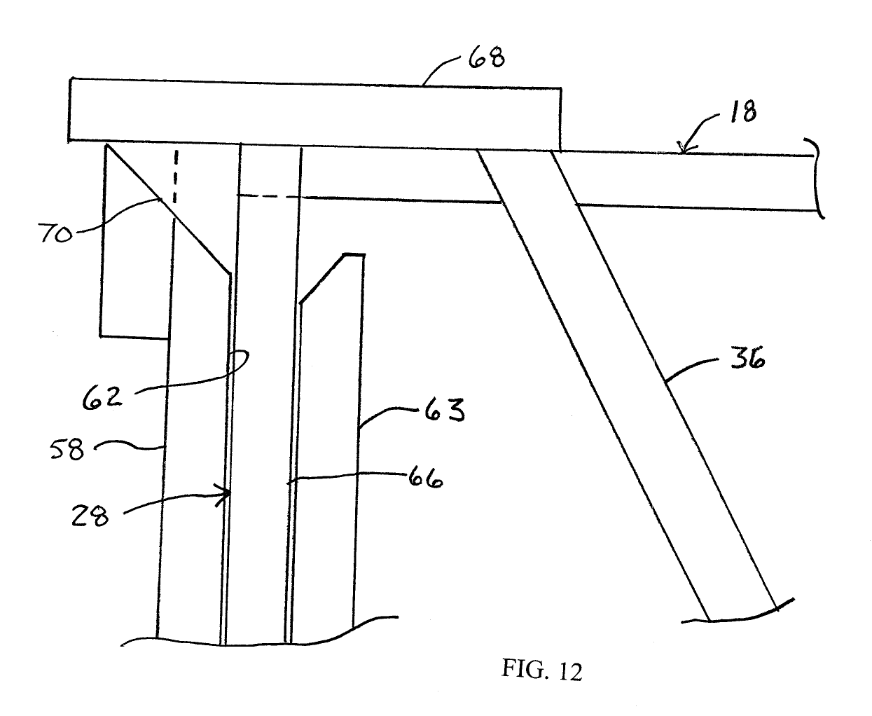

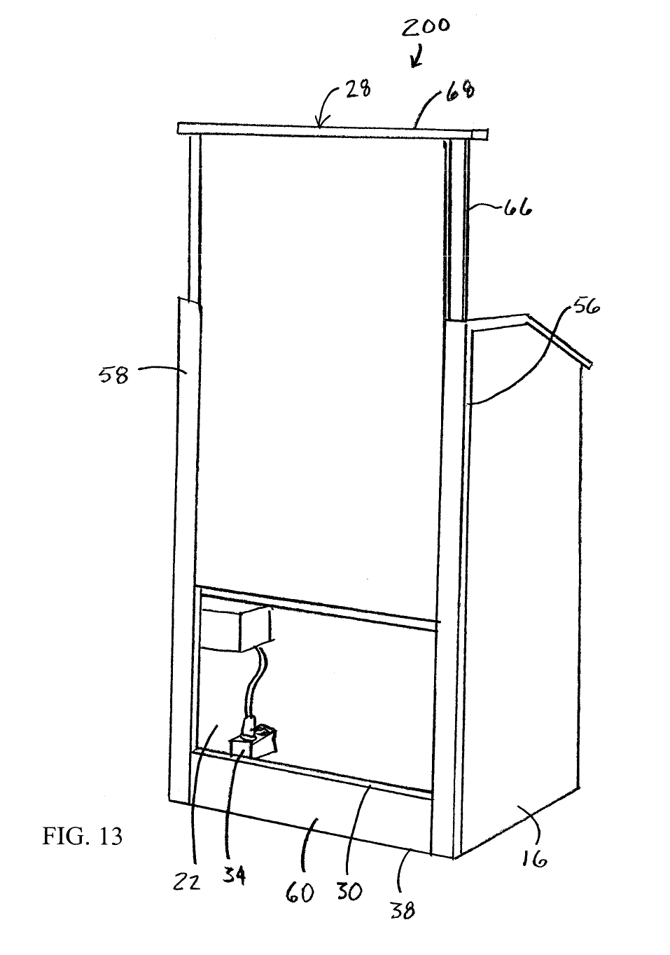

FIGS. 11 and 12 illustrate a podium 100 according to a second embodiment of the present invention. The podium 100 according to the second embodiment is substantially the same as the podium 10 according to the first embodiment except that the podium 100 has a different style or appearance. The podium 100 according to the second embodiment illustrates that the appearance of the podium can have other styles such as, for example, the illustrated “Contemporary” style. The illustrated sides 14, 16 have recessed panels 102 and the access panel 28 has matching recessed panels.

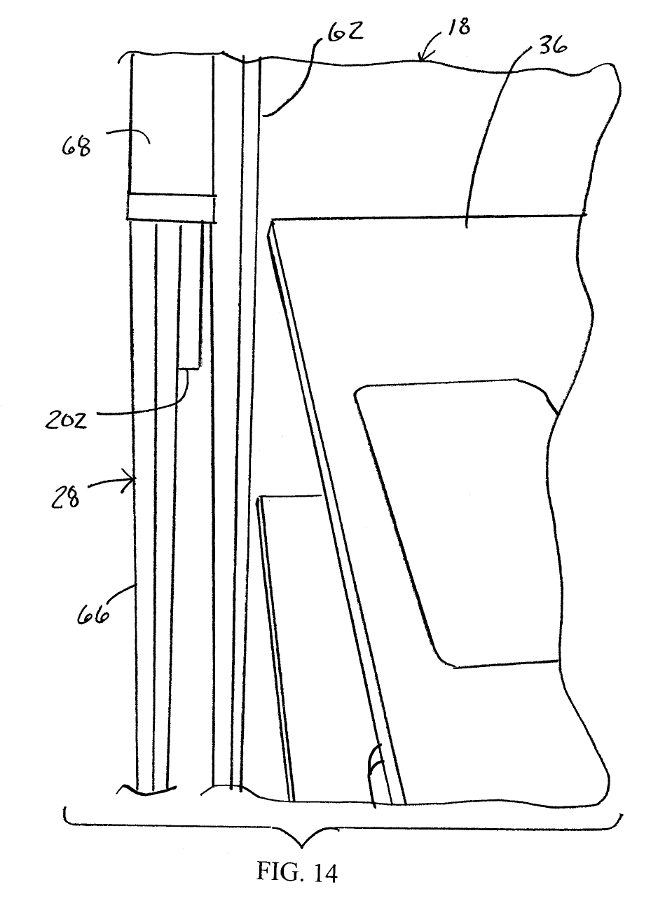

FIGS. 13 to 15 illustrate a podium 200 according to a third embodiment of the present invention. The podium 200 according to the second embodiment is substantially the same as the podiums 10, 100 according to the first and second embodiments except that the podium 200 has a yet another different style or appearance. The podium 200 according to the third embodiment illustrates that the appearance of the podium 200 can have other styles such, for example, as the illustrated “Modern” style. The illustrated sides 14, 16 are planar and flush with adjacent surfaces and the access panel 28 is also planar and flush with adjacent surfaces of the podium 200. The podium 200 according to the third embodiment further illustrates that the top side 36 of the podium 200 can have other configurations such as the illustrated elimination of the angled portion. The access panel 28 is provided with a cross member 202 on its rear side to conceal the front edge of the top side 36 in place of the previously used angle portion.

It is noted that each of the above-described features and components of the various embodiments can be used in any combination with the other features and components of the other embodiments depending on the desired use environment.

It is apparent from the forgoing that the present invention provides an improved podium by having a secure access panel 28. When the access panel 28 is locked and the podium doors 24 are locked, the access panel 28 cannot be removed to gain access to electronic components 34 from the forward side of the podium 10, 100, 200. However, when the access panel 28 is unlocked, the access panel 28 can be easily and quickly removed to gain access to the electronic components 34 from the forward side of the podium 10, 100, 200 and easily and quickly reinserted when access to the electronic components 34 is no longer needed. Additionally, because the access panel 28 is visibly concealed or hidden, thieves and pranksters do not know that the electronic equipment 34 can be accessed from the forward side of the podium 10, 100, 200 even if the access panel 28 is left unlocked and/or the podium doors 24 are left unlocked.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A podium comprising, in combination:
a plurality of upwardly extending sides and an upper surface forming an enclosure having a hollow interior space;
at least one door covering an unhidden access opening for selectively providing access to the interior space and located in a rearward one of the upwardly extending sides;
a sliding access panel removably covering a hidden access opening for selectively providing access to the interior space and located in a forward one of the upwardly extending sides; and
wherein the sliding access panel is visibly concealed so that it is not apparent that the sliding access panel is movable to provide access to the interior space.

2. The podium according to claim 1, wherein the interior space is adapted to store electronic equipment.

3. The podium according to claim 1, wherein the sliding access panel slides in a vertical direction.

4. The podium according to claim 1, wherein the at least one door is visibly unconcealed so that it is apparent to an observer that the at least one door is movable to provide access to the interior space.

5. The podium according to claim 1, wherein the forward side of the podium has a first vertically disposed side member, a second vertically disposed side member, and a horizontally disposed bottom member which cooperate to form a U-shaped frame for the sliding access panel and the access panel extends behind the U-shaped frame.

6. The podium according to claim 5, wherein pair of vertically extending and spaced-apart grooves are formed at a rearward side of the first and second side members for receiving side edges of the sliding access panel.

7. The podium according to claim 6, wherein a horizontally extending groove is formed at a rearward side of the bottom member for receiving a bottom edge of the sliding access panel.

8. The podium according to claim 5, wherein the sliding access panel includes a vertically deposed main panel and a horizontally deposed header secured to the top of the main panel and the header extends above the side members and engages the side members to support the access panel on the side members.

9. The podium according to claim 8, wherein the sliding access panel includes a molding located below the header and secured to the main panel and the header, and the molding extends entirely between the first and second side members.

10. The podium according to claim 5, wherein left and right sides of the podium have a raised panel appearance, and wherein components of the forward side of the podium provide the same raised panel appearance as the left and right sides of the podium.

11. A podium comprising, in combination:
a plurality of upwardly extending sides and an upper surface forming an enclosure having a hollow interior space;
at least one door covering a first access opening for selectively providing access to the interior space and located in a rearward one of the upwardly extending sides;
a sliding access panel removably covering a second access opening for selectively providing access to the interior space and located in a forward one of the upwardly extending sides; and
a lock for selectively locking and unlocking the sliding access panel in a closed position and located within the interior space so that the sliding access panel is locked and unlocked from within the interior space.

12. The podium according to claim 11, wherein the interior space is adapted to store electronic equipment.

13. The podium according to claim 11, wherein the sliding access panel slides in a vertical direction.

14. The podium according to claim 11, wherein the sliding access panel is visibly concealed so that it is not apparent that the sliding access panel is movable to provide access to the interior space.

15. The podium according to claim 11, wherein the lock is not visible from outside the podium.

16. The podium according to claim 11, wherein the lock includes a rod member manually movable between a locked position wherein forward end of the rod member extends into an opening located on the rear side of the sliding access panel within the interior space so that the sliding access panel cannot be slid because movement is blocked by the rod member and an unlocked position wherein the forward end of the rod member is out of the opening so that the sliding access panel is free to slide because movement is not blocked by the rod member.

17. The podium according to claim 16, wherein the lock includes a forward facing abutment so that a rearward end of the rod member engages the forward facing abutment to prevent rearward movement of the rod member out of the opening when the rod member is in the locked position and rearward end of the rod member is out of engagement with the forward facing abutment so that the rod member is free to move in the rearward direction with the rod member out of the opening when the rod member is in the unlocked position.

18. The podium according to claim 17, wherein the rod member is slidably and pivotably mounted the rod member is pivoted out of engagement with the abutment and slid in a rearward direction until the forward end of the rod is out of the opening to move the rod member from the locked position to the unlocked position.

19. The podium according to claim 16, wherein the opening is a blind hole and the rod member moves into and out of engagement with the opening in a direction perpendicular to the sliding direction of the sliding access panel and between the first and second access openings.

20. A podium comprising, in combination:
a plurality of upwardly extending sides and an upper surface forming an enclosure having a hollow interior space;
at least one door covering an unhidden access opening for selectively providing access to the interior space and located in a rearward one of the upwardly extending sides;
a sliding access panel removably covering a hidden access opening for selectively providing access to the interior space and located in a forward one of the upwardly extending sides;
wherein the at least one door is visibly unconcealed so that it is apparent to an observer that the at least one door is movable to provide access to the interior space;
wherein the sliding access panel is visibly concealed so that it is not apparent that the sliding access panel is movable to provide access to the interior space; and
a lock for selectively locking and unlocking the sliding access panel in a closed position and located within the interior space so that the sliding access panel is locked and unlocked from within the interior space and the lock is not visible from outside the podium.
